(19) United States
(12) Patent Application Publication
(10) Pub. No.: US 2013/0151312 A1
(43) Pub. Date: Jun. 13, 2013

(54) APPARATUS, METHOD, AND COMPUTER PROGRAM PRODUCT FOR COLLABORATIVE SALES CAMPAIGN

(71) Applicant: David M. Logan, Salt Lake City, UT (US)

(72) Inventor: David M. Logan, Salt Lake City, UT (US)

(21) Appl. No.: 13/714,088

(22) Filed: Dec. 13, 2012

Related U.S. Application Data
(60) Provisional application No. 61/570,217, filed on Dec. 13, 2011.

(51) Int. Cl. G06Q 30/02

(52) U.S. Cl. CPC G06Q 30/0202
USPC 705/7.31

(57) ABSTRACT

An apparatus, method, and computer program product are disclosed for a collaborative sales campaign system. An organization contact module is configured to register an organization contact on a website. The organization contact represents the organization. A supporter module is configured to register supporters at the website for a product sales campaign associated with an organization such that the total number of the supporters meets a predetermined threshold. Further, a sales module is configured to initiate the product sales campaign in response to registering the organization contact and in response to registering the supporters. Finally, a product module is configured to signal a manufacturer of the product to produce the product when the number of committed purchases by supporters exceeds the predetermined threshold.

### CROSS-REFERENCES TO RELATED APPLICATIONS

This application claims the benefit of U.S. Provisional Patent Application No. 61/570,217 entitled “APPARATUS, SYSTEM, AND METHOD FOR A COLLABORATIVE SALES CAMPAIGN” and filed on Dec. 13, 2011 for David Logan, which is incorporated herein by reference.

### FIELD

This invention relates to group buying and more particularly to a buyer driven collaborative sales campaign.

### BACKGROUND

Organizations, such as schools, hold fundraisers to gain funds to support their activities and causes. Often, the fundraisers will offer products that people can purchase, with proceeds going to the organization. However, holding fundraisers involving product sales presents various problems for organizations.

First, the manufacturer often requires a minimum number of products to be purchased at one time, requiring the organization to come up with a large sum of money up front. Second, it is difficult for the organization to plan on the number of people they expect to purchase the products, with the organization being left with the products that did not sell. Third, it may be difficult to generate support for the fundraising event beyond the reach of those with direct contact with the organization.

Fundraising organizations may join in the benefits offered by group buying to help alleviate these concerns. Group buying offers products and services at significantly reduced prices on the condition that a minimum number of buyers make the purchase. If the threshold number of purchases is not met, then the group does not get the benefit of the offer. Many group buying systems are maintained on a website and have become a major component of the online shopping business. However, many online group buying systems are driven by a retailer or manufacturer that presents a pre-manufactured product at a discounted price if a minimum number of purchases are made.

### SUMMARY

From the foregoing discussion, it should be apparent that a need exists for an apparatus, method, and computer program product that provide a buyer driven collaborative sales campaign system. Beneficially, such an apparatus, method, and computer program product would be available to organizations and manufacturers, provide a buyer driven group buying system, and provide a support building system through social media and other networking services.

The present invention has been developed in response to the present state of the art, and in particular, in response to the problems and needs in the art that have not yet been fully solved by currently available tracking systems. Accordingly, the present invention has been developed to provide an apparatus, method, and computer program product for a buyer driven collaborative sales campaign system that overcome many or all of the above-discussed shortcomings in the art.

The collaborative sales campaign system is provided with a plurality of modules configured to functionally execute the necessary steps of providing a collaborative sales campaign. These modules in the described embodiments include an organization contact module configured to register an organization contact on a website. In one embodiment, the organization contact represents the organization. A supporter module, in one embodiment, is configured to register supporters at the website for a product sales campaign associated with an organization. The number of supporters, in one embodiment, meets a predetermined threshold. Moreover, a sales module, in one embodiment, is configured to initiate the product sales campaign in response to registering the organization contact and in response to registering the supporters. Finally, the product module, in another embodiment, is configured to signal a manufacturer of the product to produce the product in response to a number of committed purchases by the supporters exceeding the predetermined threshold.

A design module, in one embodiment, may be provided to select design options for a product for the product sales campaign and present the design options to users on a website. In other embodiments, the design module receives votes for design options from the users through the website and may select a particular design for the product sales campaign according to the particular design option having the highest number of votes. The system further includes, in one embodiment, a reward event module configured to detect a reward event of a supporter of a product sales campaign and a reward module configured to detect a reward event associated with a supporter. In certain embodiments, the reward module credits a reward to the supporter in response to the reward event module detecting the reward event. In other embodiments, an interface module may be included to interface with one or more social media networks to facilitate the supporters referring additional supporters. Moreover, a credit module may be provided to credit the organization with at least a portion of each finalized committed purchase and credit the sales campaign provider with a portion of each finalized committed purchase. In other embodiments, a buyer module is provided that registers a buyer in response to the buyer purchasing a product. In other embodiments, the buyer module records the buyer's payment information.

A method of the present invention is also presented for a collaborative sales campaign. The method in the disclosed embodiments substantially includes the steps necessary to carry out the functions presented with respect to the operation of the described apparatus and system. In one embodiment, the method includes registering supporters at a website for a product sales campaign associated with an organization such that the number of supporters meets a predetermined threshold. The method also may include registering an organization contact at the website. In one embodiment, the organization contact represents the organization. In one embodiment, the method includes initiating the product sales campaign in response to registering the organization contact and in response to registering the supporters. In a further embodiment, the method includes signaling a manufacturer of the product to produce the product in response to a number of committed purchases by the supporters exceeding the predetermined threshold.

The method, in other embodiments, includes introducing a product to a sponsoring entity, collaboratively selecting a design of the product, and collaborating, through a website, to establish a threshold amount of committed purchases of the product. In one embodiment, the method further includes setting a price of a product for sale on a website to an initial value, detecting when the number of committed purchases of the product exceeds a predetermined threshold, and lowering the price in response to each committed purchase above the predetermined threshold. In further embodiments, the method selects design options for a product for the product sales campaign and presents the design options to users on a website. In other embodiments, the method receives votes for design options from the users through the website and selects a particular design for the product sales campaign according to the particular design option having the highest number of votes. The method, in other embodiments, includes managing a product sales campaign on a website, detecting a reward event of a particular supporter of the product sales campaign, and crediting a reward to the particular supporter in response to detecting the reward event. The method further may include interfacing with one or more social media networks to facilitate the plurality of supporters referring a plurality of additional supporters.

A computer program product of the present invention is also presented to provide a collaborative sales campaign system. The computer program product, in one embodiment, registers supporters at a website for a product sales campaign associated with an organization such that the number of supporters meets a predetermined threshold. In one embodiment, the computer program product registers an organization contact at the website. In certain embodiments, the organization contact represents the organization. Moreover, the computer program product initiates the product sales campaign in response to registering the organization contact and in response to registering the supporters. In one embodiment, the computer program product signals a manufacturer of the product to produce the product in response to a number of committed purchases by the supporters exceeding the predetermined threshold.

The computer program product, in some embodiments, further includes introducing a product to a sponsoring entity, collaboratively selecting a design of the product, and collaborating, through a website, to establish a threshold amount of committed purchases of the product. In other embodiments, the computer program product includes setting a price of a product for sale on a website to an initial value, detecting when the number of committed purchases of the product exceeds a predetermined threshold, and lowering the price in response to each committed purchase above the predetermined threshold. In further embodiments, the computer program product selects design options for a product for the product sales campaign and presents the design options to users on a website. In other embodiments, the computer program product receives votes for design options from the users through the website and selects a particular design for the product sales campaign according to the particular design option having the highest number of votes.

The computer program product, in one embodiment, includes managing a product sales campaign on a website, detecting a reward event of a particular supporter of the product sales campaign, and crediting a reward to the particular supporter in response to detecting the reward event. In another embodiment, the computer program product further includes crediting the organization with at least a portion of each finalized committed purchase and interfacing with one or more social media networks to facilitate the supporters referring additional supporters.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the subject matter disclosed herein will be readily understood, a description of the subject matter will be rendered by reference to specific embodiments that are illustrated in the appended drawings. Understanding that these drawings depict only typical embodiments of the subject matter and are not therefore to be considered to be limiting of its scope, the present subject matter will be described and explained with additional specificity and detail through the use of the accompanying drawings, in which:

FIG. 1 is a schematic block diagram illustrating one embodiment of a system for a collaborative sales campaign in accordance with the present subject matter;

FIG. 2 is a schematic block diagram illustrating another embodiment of a system for a collaborative sales campaign in accordance with the present subject matter;

FIG. 3 is a schematic block diagram illustrating one embodiment of an apparatus for collaborative sales campaign in accordance with the present subject matter;

FIG. 4A depicts an embodiment of a design options registration webpage for an organization contact in accordance with the present subject matter;

FIG. 4B depicts an embodiment of a referral center webpage in accordance with the present subject matter;

FIG. 4C depicts an embodiment of a main sales campaign webpage in accordance with the present subject matter;

FIG. 5 is a schematic flow chart diagram illustrating one embodiment of method for a collaborative sales campaign in accordance with the present subject matter;

FIG. 6 is a schematic flow chart diagram illustrating a second embodiment of method for a collaborative sales campaign in accordance with the present subject matter;

FIG. 7 is a schematic flow chart diagram illustrating a third embodiment of method for a collaborative sales campaign in accordance with the present subject matter;

FIG. 8 is a schematic flow chart diagram illustrating a fourth embodiment of method for a collaborative sales campaign in accordance with the present subject matter;

FIG. 9 is a schematic flow chart diagram illustrating a fifth embodiment of method for a collaborative sales campaign in accordance with the present subject matter; and

FIG. 10 is a detailed schematic flow chart diagram illustrating a sixth embodiment of method for a collaborative sales campaign in accordance with the present subject matter.

### DETAILED DESCRIPTION

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present subject matter may be written in any combination of one or more programming languages, including an object oriented programming language such as Java, Smalltalk, C++ or the like, conventional procedural programming languages, such as the “C” programming language or similar programming languages, and scripting languages such as Flash Action Script, PHP, JavaScript, Ruby and AJAX. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

All or a portion of the methods in the disclosed embodiments may be performed by and/or comprise a computer program product comprising a computer readable storage medium storing computer usable program code executable to perform operations comprising the methods.

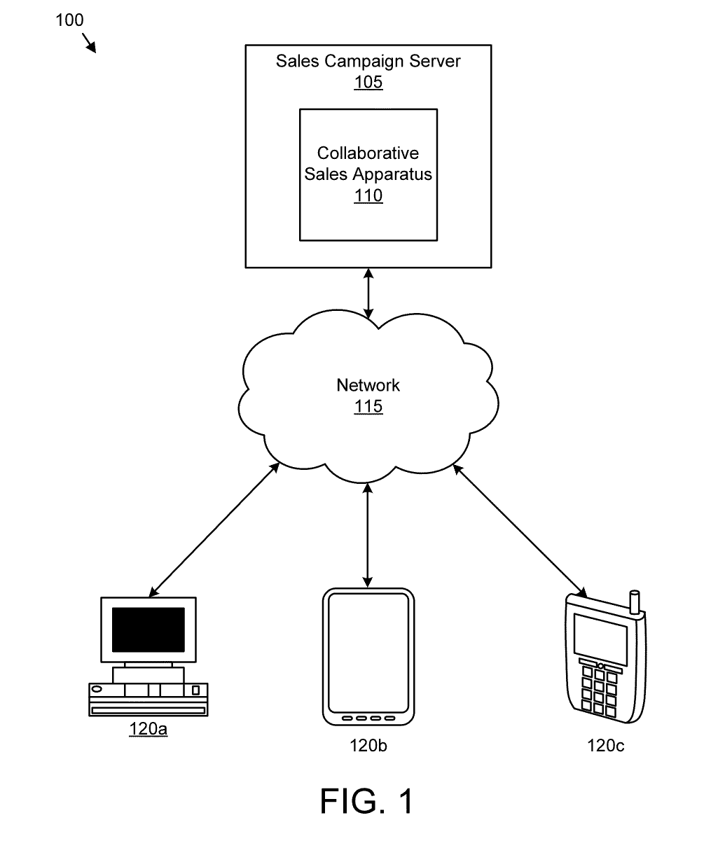

FIG. 1 depicts one embodiment of a system 100 for a collaborative sales campaign. The system 100 includes a sales campaign server 105 with a collaborative sales apparatus 110, a network 115, and a plurality of clients 120a-c. The sales campaign server 105 hosts, stores, and/or provides one or more websites for access, and/or download over the network 115 by the plurality of clients 120a-c as is known in the art.

The sales campaign server 105 may be embodied as a computing device including a desktop computer, a portable computer, a server, a mainframe computer, and the like. The sales campaign server 105 may include memory storing computer readable programs. The sales campaign server 105 may include a processor that executes the computer readable programs as is well known to those skilled in the art. The computer readable programs may be tangibly stored in storage in communication with the electronic publication server. Although FIG. 1 depicts a single sales campaign server 105, one skilled in the art realizes that the system may include multiple sales campaign servers 105.

The network 115 may comprise a global communications network such as the Internet, a Local Area Network (LAN), multiple LANs communicating over the Internet, or any other similar communications network. Each client 120a-c may be embodied as a desktop computer, a portable computer, a server, a mainframe computer, a handheld computing device, a touch device, a personal desktop assistant (“PDA”), a tablet computer, an e-Book reader, a mobile phone, a Smartphone, and the like. Each client 125a-c may communicate, using a software application such as an Internet browser, with the sales campaign server 105 to access, retrieve, and/or download webpages from one or more websites as is known in the art.

Holding fundraisers that involve the sale of one or more products, such as for schools and other organizations, can be difficult. Specifically, a product manufacturer 210 often requires a minimum order of products requiring the fundraising organization to come up with a significant sum of money up front. Furthermore, if not all of the products in the minimum order are sold, the fundraising organization is often left with the remaining products. In addition, support for the fundraiser may be difficult to generate past those students or direct participants in the group or organization holding the fundraiser.

Therefore, the sales campaign server 105, in the depicted embodiment, includes a collaborative sales apparatus 110 that allows for collaboratively selling products in product sales campaigns. Specifically, the collaborative sales apparatus 110 may bring multiple parties together to introduce a product to a sponsoring entity or organization, collaboratively select a design of the product, and collaborate, through a website, to establish a threshold amount of committed purchases of the product. Once the threshold amount of committed purchases has been reached, in one embodiment, the collaborative sales apparatus 110 may notify a manufacturer of the product to produce the product and/or begin lowering the price for each committed purchase above the threshold (meaning that the price per item goes down for everyone, even those who have also committed to purchase the item). The collaborative sales apparatus 110 may also offer rewards to participants in sales campaigns and those that view or perform other actions on the website. The collaborative sales apparatus 100 may interface with social networking sites, and/or facilitate participants referring others to visit the website, make a committed purchase, and/or the like.

As stated above, in one embodiment, the collaborative sales apparatus 110 provides a website embodied as one or more web pages available for access over the network 115 by the clients 125a-c. Each web page may include software code, images, and text. Specifically, each web page may include static and/or dynamic elements and include Hypertext Markup Language (“HTML”) code, JavaScript code, Flash animations, and the like.

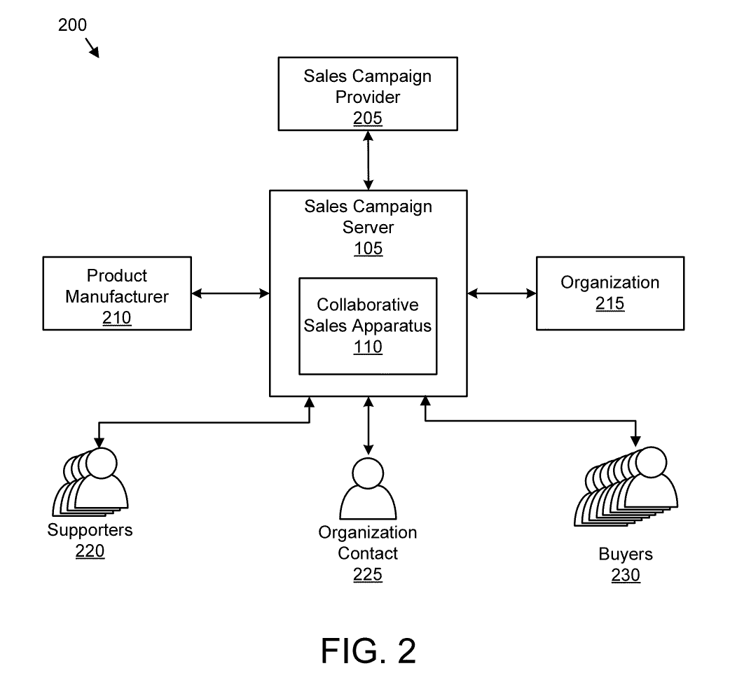

FIG. 2 depicts another embodiment of a system 200 for a collaborative sales campaign. The system 200 includes a sales campaign server 105 with a collaborative sales apparatus 110 that may be substantially similar to the like numbered elements depicted in FIG. 1. The system also includes a sales campaign provider 205, a product manufacturer 210, an organization 210, a plurality of supporters 220, an organization contact 225, and a plurality of buyers 230. Each of the entities comprising the sales campaign provider 205, the product manufacturer 210, the organization 210, the plurality of supporters 220, the organization contact 225, and the plurality of buyers 230 may be in communication with the sales campaign server 105 and the collaborative sales apparatus 110 (e.g. each of these entities communicates using a client device 120 as described above). For example, a supporter 220 may view the website of the collaborative sales apparatus 110 from a browser executing on a smartphone or a personal computer, the product manufacturer 210 may operate a server and/or other computing device capable of receiving, from the collaborative sales apparatus 110, product design information, product quantities, a signal to begin manufacturing a product and/or the like.

The collaborative sales apparatus 110 provides, hosts, and or manages sales campaigns for the organization 210. A sales campaign is an event to generate money for the organization 210 that involves selling one or more particular lines of products on the website. In one embodiment, the sales campaigns each last for a set time and buyers 230 are able to make committed purchases through the website. A committed purchase means that the buyer 230 commits to buy a specified quantity of the product if a threshold amount of products have been ordered (e.g. through committed purchases) by the time the sales campaign ends. If the threshold amount is not reached, in one embodiment, the buyer 230 does not buy the product and, in one embodiment, the manufacturer does not manufacture the product.

The sales campaign provider 205 hosts, provides, manages, and/or owns the collaborative sales apparatus 110. The sales campaign provider 205 makes the collaborative sales apparatus 110 and the website available to users including the product manufacturer 210, the organization 210, the plurality of supporters 220, the organization contact 225, and the plurality of buyers 230. In one embodiment, the sales campaign provider 205 also receives a portion of each committed purchase.

The product manufacturer 210 may receive design information (e.g. logos, color schemes, and the like) from the organization 210 and/or the organization contact 225 and creates design options for products for sales campaigns. The product manufacturer 210 may send design options for a particular product to the collaborative sales apparatus 110 and may manufacture the particular product according to a selected design option after receiving a notification that a threshold amount of committed purchases of the product have been made. The product manufacturer 210 may manufacture such products as blankets, stickers, sporting equipment, clothing, or any other suitable product. In one embodiment, the product manufacturer 210 and/or users representing the product manufacturer 210 may register with the collaborative sales apparatus 110 and obtain one or more user accounts. The collaborative sales apparatus 110 may classify the user account(s) as pertaining to a product manufacturer 210. Although a single product manufacturer 210 is depicted, the system 200 may include multiple product manufacturers 210.

The organization 210 may be a school, a club or group at a school, a business, a sports team, or other suitable organization 210. The organization 210, in one embodiment, is an organization 210 that performs fundraisers to acquire funds to cover certain expenses. For example, the organization 210 may be a high school or a group at a high school. The organization 210 may have one or more sub-organizations, each with their own sales campaigns. In one embodiment, the organization 210 and/or users representing the organization 210 may register with the collaborative sales apparatus 110 and obtain one or more user accounts. The collaborative sales apparatus 110 may classify the user account(s) as pertaining to a product manufacturer 210.

Although a single organization is depicted, the system 200 may include multiple organizations 210. In one embodiment, the collaborative sales apparatus 110 maintains a separate website, group of webpages, and/or portal for each organization 210, sub-organization, and/or sales campaign. Therefore, in one embodiment, a user for the organization 210 may log in to the website and see one or more sales campaigns for the organization 210 without seeing sales campaigns for unrelated organizations. Each website, portion of the website, and/or group of webpages specific to an organization, sub-organization, and/or sales campaign may be tailored to the organization, sub-organization, or sales campaign (e.g. with logos, organization name, colors, and the like).

The plurality of supporters 220 includes users who have registered with the collaborative sales apparatus 110 for a particular sales campaign that is ongoing, or for past sales campaigns. In one embodiment, a supporter 220 may be a user who registers with the website not in association with any sale campaign, but for news on future sales campaigns. In one embodiment, at least a portion of the plurality of supporters 220 are unrelated to the organization 210 and/or lack the authority to accept payment on behalf of the organization 210. In one embodiment, each supporter 220 registers with the collaborative sales apparatus 110 and obtains a user account. The collaborative sales apparatus 110 may classify the user account(s) as pertaining to a supporter 220.

In one embodiment, a product sales campaign is initiated by a supporter 220 (e.g. a first supporter 220), who then recruits a predetermined number of initial supporters 220 and an organization contact 225 before the product sales activity is commenced. In one embodiment, supporters 220 are instructed to spread the word about the product sales campaign and to recruit buyers 230 for the product. In another embodiment, supporters 220 may actively recruit other supporters through their social network or email messages, which may be created and distributed by the sales campaign provider 205.

The organization contact 225 may be one or more users representing the organization 210 (e.g. with the authority to accept payment from a sales campaign for the organization 210). The organization contact 225 may help configure a sales campaign as described below. The organization contact 225 may also be a supporter 220. In one embodiment, the organization contact 225 registers with the collaborative sales apparatus 110 and obtains a user account. The collaborative sales apparatus 110 may classify the user account(s) as pertaining to an organization contact 225.

In one embodiment, a product sales campaign may be initiated by the organization contact 225, who may then recruit a predetermined number of initial supporters 220 before the product sales activity is commenced.

The plurality of buyers 230 may be users, individuals, organizations, and/or groups that place committed purchases on products in one or more sales campaigns. A buyer 230 may also be a supporter and/or an organization contact 225. In one embodiment, a buyer 230 registers with the collaborative sales apparatus 110 and obtains a user account prior to or in association with placing a committed purchase. The collaborative sales apparatus 110 may classify the user account(s) as pertaining to a buyer 230.

In certain embodiments, the sales campaign provider 205, the product manufacturer 210 and the organization 210 comprise distinct, unrelated entities. Furthermore, in one embodiment, the supporters 220 and/or the buyers 230 are distinct and separate entities from the sales campaign provider 205, the product manufacturer 210 and the organization 210. Furthermore, in one embodiment, the website and/or the collaborative sales apparatus 110 are independent of the organization 210.

In addition, the collaborative sales apparatus 110 may store user account information in a database, a flat file, or other suitable storage system. The collaborative sales apparatus 110 may maintain attributes for the user accounts such as usernames, passwords, past sales, organization name, and the like.

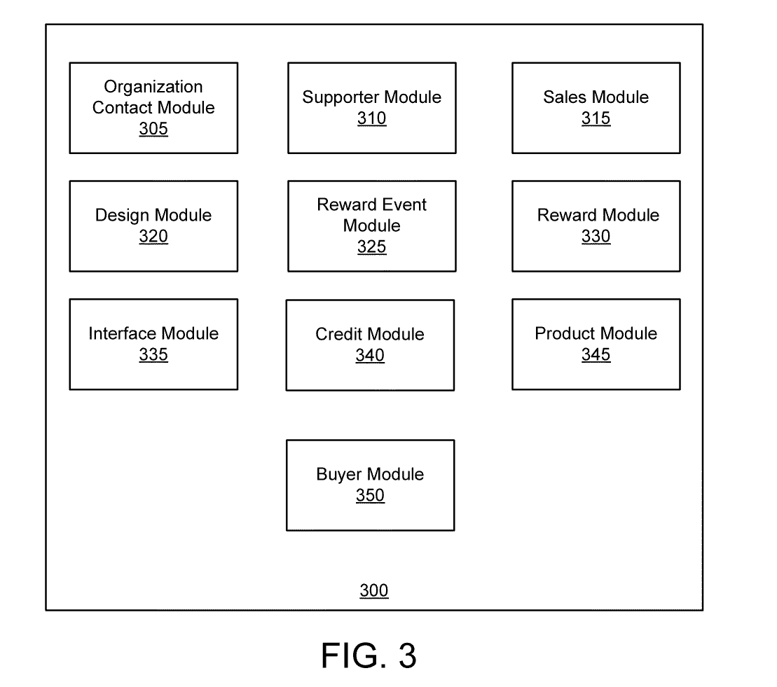

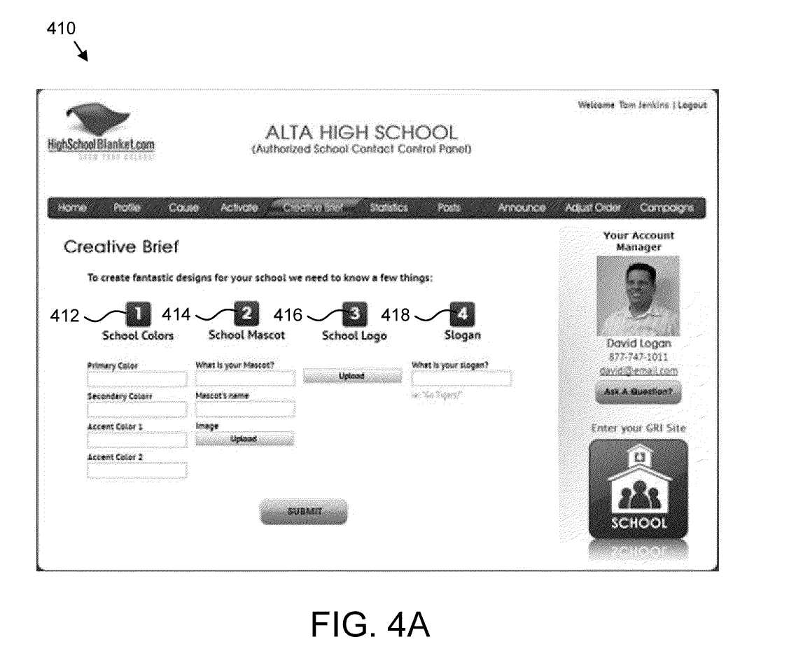

FIG. 3 depicts one embodiment of an apparatus 300 for collaborative sales activity. Specifically, the apparatus 300 may comprise one embodiment of the collaborative sales apparatus 110. The description of the apparatus 300 refers to elements of FIGS. 1-2, like numbers referring to like elements. The apparatus 300 includes one or more of an organization contact module 305, a supporter module 310, a sales module 315, a design module 320, a reward event module 325, a reward module 330, an interface module 335, a credit module 340, a product module 345, and a buyer module 350. Moreover, while the depicted embodiment includes the above listed modules, in certain embodiments, the apparatus 300 may include a subset of the depicted modules alone and/or the modules in various combinations. Note that the description of FIG. 3 references FIGS. 4A-4C. While FIGS. 4A-4C describes a product sales campaign in context of a school fundraiser, any suitable organization 210 may be used. Furthermore, the web pages in FIGS. 4A-4C are included as non-limiting example embodiments.

The organization contact module 305, in one embodiment, registers an organization contact 225 at the website. The organization contact 225 represents an organization 210 related to a sales campaign or a potential sales campaign. The organization contact module 305 may create a user account for the organization contact 225. In one embodiment, a webpage may provide a link for the organization contact 225 to begin the registration process. The organization contact module 305, in one embodiment, may provide one or more “control panel” web pages for the organization contact 225 to allow the organization contact 225 to set up a product sales campaign.

The organization contact module 305, in certain embodiments, allows the organization contact 225 to fill in organization information and user account information in a webpage. The organization contact module 305, in certain embodiments, provides a webpage that allows the organization contact 225 to fill in a cause (e.g. for fundraising activities). The organization contact module 305 may provide the organization contact 225 with a platform, to fulfill requirements to begin a product sales campaign (e.g. recruit a predetermined number of supporters 220) and activate the product sales campaign.

In one embodiment, referring also to FIG. 4A, the organization contact may input design elements 412-418 to aid in the selection of design options as described below. In other embodiments, the organization contact module 305 may maintain statistics on one or more product sales campaigns such as a number of supporters 220, time remaining, a current price, and/or the like as displayed in a webpage 428 of the website. The organization contact module 305 also allows the organization contact 225 to order additional products.

The supporter module 310, in one embodiment, registers a plurality of supporters 220 at the website for a particular product sales campaign. The product sales campaign may be associated with an organization 210. The supporter module 310 may register initial supporters 220, or supporters 220 required to begin a product sales campaign. In one embodiment, the supporter module 310 registers a first supporter 220, who may then recruit additional supporters 220. In one embodiment, the website may provide a link for the first supporter 220 to begin the registration process. In one embodiment, a product sales campaign does not commence until a predetermined number of supporters 220 is reached.

The supporter module 310 may also register additional supporters 220 after the product sales campaign has begun. In one embodiment, an initial supporter 220 (e.g. one beginning a product sales campaign) obtains a complementary product of the product sales campaign. The supporter module 310 may indicate, on the user account of the initial supporter 220, that the initial supporter 220 should receive the complementary product. In certain embodiments, the supporter module 310 may provide one or more web pages 432 allowing users to register as supporters 220 and/or displaying statistics relating to supporters. For example, the supporter module 310 may provide a leader board to display which supporters are in the lead with regards to reward points or “gems” earned. In another embodiment, the supporter module 310 may provide a personal influence page to display a supporter's circle of influence, i.e., supporters the user has referred, and the supporters that they referred, and so on.

In one embodiment, the supporter module 310 allows a user to register as a supporter 220 using the user's social network login credentials. For example, in one embodiment, the supporter module 310 interfaces with one or more social network websites to allow for user account creation based on a user's social network account (e.g. a Facebook account). The supporter module 310 may then send notifications of a supporter's actions on the website to the user's social network profile to appear in updates, messages, and/or the like of the user on the social network site.

The sales module 315, in one embodiment, manages on or more sales campaigns and/or collaborates, through the website, to establish a threshold amount of committed purchases of a particular product. In one embodiment, the sales module 315 initiates a product sales campaign in response to registering the organization contact 225 and in response to registering a predetermined number of supporters 220 for the product sales campaign.

In one embodiment, the sales module 315 sets a price of a product to an initial value and may record committed purchases of the product. The sales module 315 may display the initial price on the website along with the product. In one embodiment, the sales module 315 detects a plurality of committed purchases of the product pass (e.g. a number of products sold) a predetermined threshold (e.g. the tipping point). The predetermined threshold may be the point at which the manufacturer has agreed to manufacture the product.

In one embodiment, the sales module 315 lowers the price of the product in response to each committed purchase above the predetermined threshold. The price may be lowered for everyone—those that have already made committed purchases of the product and those that have yet to make committed purchases of the product. The sales module 315 may display the current price of the product such that viewers of the website may see the price drop and may have incentive to find more people to make committed purchases for the product to lower the price for everyone.

In one embodiment, the sales module 315 detects a length of time for the product sales campaign pass a predetermined time threshold. The sales module 315 then finalizes the committed purchases in response to establishing the threshold amount of committed purchases and in response to the product sales campaign ending. In one embodiment, the sales module 315, as part of finalizing the committed purchases, references stored payment information (e.g. credit card information) for each buyer 230 of a committed purchase and processes and/or initiates processing of the payment information. The sales module 315 may also send a notification to each buyer 230 at an email address, social media network account, or the like, informing the buyer 230 that the product sales campaign has ended, that the predetermined number of products was reached, the final sales prices, a total purchase amount, and/or the like.

In one embodiment, the sales module 315 receives payment commitments from one or more proxy buyers in behalf of a particular buyer 230. For example, a user may recruit others to pay for the product in behalf of the user. The sales module 315 may place a committed purchase of the product for the particular buyer 230 in response to receiving the payment commitments.

FIG. 4C depicts one embodiment of a product sales campaign main webpage 430. Specifically, the sales module 315 in one embodiment, may display an organization name 432, a total amount raised 434 (in fundraising embodiments), a picture of the product 436, time remaining in the product sales activity 438, a current amount of products bought 440 (e.g. those assigned in committed purchases) and the price for the products 442, and/or the like. Of course, the website 430 may display any other suitable information regarding the product sales campaign. A user may view the current price of the product (the price the product will be for everyone) and may be incentivized to recruit other buyers 230 to lower the price of the product for everyone.

Referring again to FIG. 3, the design module 320, in one embodiment, collaboratively selects a design of a product for a product sales campaign. In certain embodiments, the design module 320 selects a plurality of design options for a product for a product sales campaign. In one embodiment, the design module 320 receives one or more design elements from the organization contact 225 and/or the organization 210. For example, the organization contact 225 may upload organization colors, graphics, logos, and/or the like to the design module 320. The design module 320 may communicate these design elements to the product manufacturer 210 or other designer of the product options. The product options presented for voting may be based on these design elements. FIG. 4A depicts one embodiment of a design element entry form webpage 410 in the organization contact control center with fields to specify design elements for an organization 210 (e.g. a school in the depicted embodiment) including an organization color 412, an organization mascot 414, an organization logo 416, and an organization slogan 418.

Referring back to FIG. 3, in one embodiment, the design module 320 presents the plurality of design options to a plurality of users on the website. The plurality of users may include supporters 220, buyers 230, or other viewers of the website, such as those referred to the website from supporters 220 or buyers 230. In one embodiment, the design module 320 allows users to vote on the designs and the design module 320 receives votes for design options of the plurality of design options from the plurality of users through the website. The design module 320 may select a particular design option of the plurality of design options having the highest number of votes. In another embodiment, the design module 320 provides a collaborative message board for supporters to post messages on various topics regarding the product design or the product generally.

Referring back to FIG. 3, the reward event module 325, in one embodiment, detects a reward event of a particular supporter 220 of the product sales campaign. The reward event may include, but is not limited to a committed purchase for the product by the particular supporter 220, a vote by the particular supporter 220 for a product design for the product, a viewed video by the particular supporter 220, a visitor to the website referred by the particular supporter 220, a committed purchase referred by the particular supporter 220, and an additional supporter 220 joining the product sales campaign referred by the particular supporter 220. A particular supporter 220 may receive reward events for actions of users “down the chain.” For example, if User A refers User B to the website, then User A may receive a reward. If User B refers User C to the website and User C makes a committed purchase, both User B and User A may receive a reward. In one embodiment, a particular supporter 220 receives a reward in response to recruiting another organization to have its own product sales campaign and for sales made in that organization's product sale campaign.

The reward module 330 may detect a reward event by detecting a supporter 220 performing various actions while logged into the supporter's 220 user account (e.g. voting, watching a video on the website, and the like). The reward module 330 may detect a reward event (e.g. referrals) by detecting a unique identifier for the supporter 220 in clicked links made by other visitors coming to the site, making purchases, watching videos, and the like. For example, if User A sends a link to User B through the website (e.g. through the interface module 335), the link may include an identifier unique to User A. If User B subsequently visits the website using the link, the reward module 330 detects the identifier and knows that User A referred User B to the site. User A may receive rewards for User B's subsequent activities on the website.

In one embodiment, the reward includes points or currency good for products, prizes, and the like on the website or on third party websites. The reward may, in one embodiment, be a non-cash reward good for discounts or for redemption on products and services. In one embodiment, the reward comprises cash. In other embodiments, the reward may include being entered in drawings or raffles to win prizes such as trips, products, or the like. In certain embodiments, users may be rewarded with “gems,” which are distributed to a user for performing an action that creates some kind of monetary value, for example, a referral that purchases an item, referring another organization that starts a campaign, and the like. In one embodiment, a user may collect and exchange “gems” for products available in a “gem” store.

The reward module 330, in one embodiment, credits a reward to the particular supporter 220 in response to the reward event module 325 detecting the reward event. The reward module 330 may change a field in a database entry for the particular supporter 220 to reflect the reward, may send notification of the reward to the particular supporter's 220 social network account, and the like. In one embodiment, the reward module 330 provides badges and achievement a user may earn for performing certain tasks, such as watching a video or referring a certain number of supporters.

Referring again to FIG. 3, the interface module 335, in one embodiment, interfaces with one or more social media networks, email systems, instant messaging systems, or the like. The interface module 335 may provide users (supporters 220, buyers 230, unregistered viewers of the website, and the like) with a convenient way to announce the product sales campaign on the users' social media networks. In one embodiment, a user may choose to send an invitation or announcement of the product sales activity to the user's social media contacts, email contacts, instant messaging contacts, or the like. Referring to FIG. 4B, the website may provide a webpage 420 to allow the user (e.g. a supporter 220) to select a particular social network or messaging method 422 to spread word of the product sales campaign. In one embodiment, the interface module 335 provides a message form 424 for the user to fill out, allows the user to select which contacts to send the message to 426, and the like. In one embodiment, the interface module 335 records actions that a user performs on the website onto the user's social network profile. In another embodiment, the interface module 335 provides prewritten messages that a user may select to send to their contacts.

Referring back to FIG. 3, the credit module 340, in one embodiment, credits the organization 210 with at least a portion of each finalized committed purchase. The credit module 340 may also credit the sales campaign provider 205 with a portion of each finalized committed purchase and/or a flat fee for providing the website.

The product module 345, in one embodiment, initiates manufacture of the product according to the particular design option (e.g. that selected by voters for the particular product sales campaign) in response to reaching a threshold amount of sales of the product. In one embodiment, the product module 345 signals and/or notifies the product manufacturer 210 to proceed and manufacture the product (e.g. in response to a product sales campaign ending and in response to the threshold amount of products being sold).

The buyer module 350 registers a buyer 230 in connection with the buyer 230 buying (e.g. requesting a committed purchase) the product. The buyer module 350, in one embodiment, records the buyer's 230 payment information (e.g. a credit card number, debit card number, PayPal information, or the like) for charging when the product sales campaign ends if the threshold number of products was sold. In one embodiment, the buyer module 350 assigns a buyer 230 a separate user account, for example, if the buyer 230 is not also a supporter 220. In one embodiment, the buyer module 350 designates a supporter's 220 user account as also a buyer user account.

In one embodiment, the buyer module 350 allows a user to register as a buyer 230 using the user's social network login credentials as described above in relation to the supporter module 310.

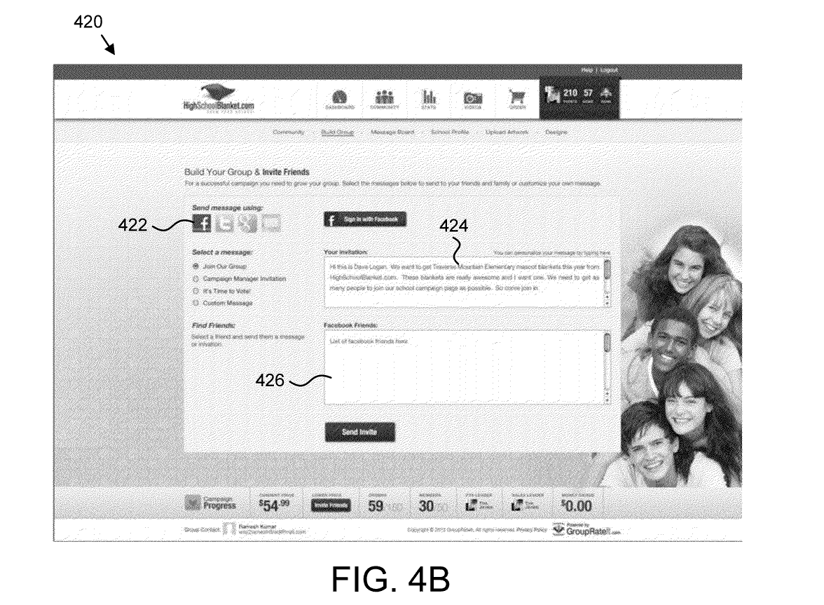

FIG. 5 depicts one embodiment of a method 500 for a collaborative sales campaign. The method 500 begins and the collaborative sales apparatus 110 introduces 505 a product to a sponsoring entity. The collaborative sales apparatus 110 collaboratively selects 510 a design of the product. Then, the collaborative sales apparatus 110 collaborates, through a website, to establish 515 a threshold amount of committed purchases of the product. Then, the method 500 ends.

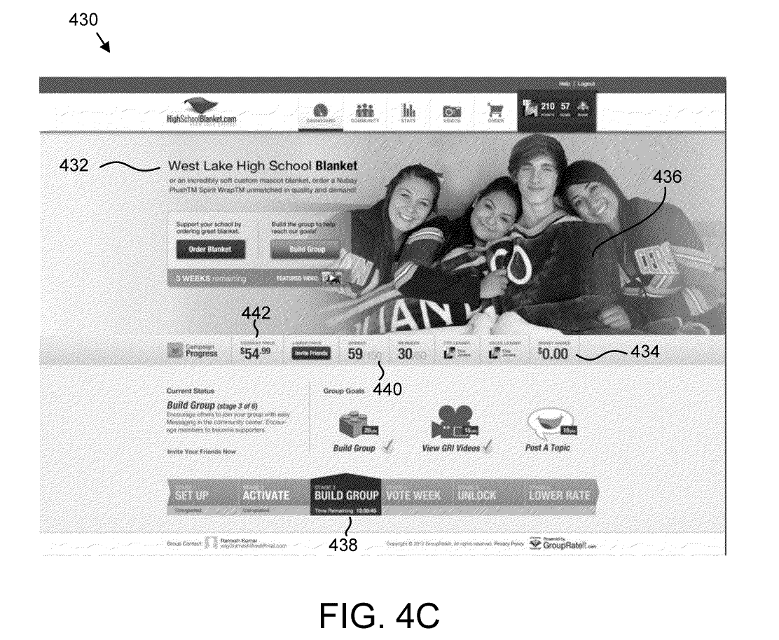

FIG. 6 depicts a second embodiment of a method 600 for a collaborative sales campaign. The method 600 begins and the sales module 315 sets 605 a price of a product to an initial value. The product is for sale on a website. The sales module 315 detects 610 a plurality of committed purchases of the product pass a predetermined threshold and the sales module 315 lowers 615 the price in response to each committed purchase above the predetermined threshold. In one embodiment, the price is lowered for each committed purchase including those that made committed purchases before the predetermined threshold was met. Then the method 600 ends.

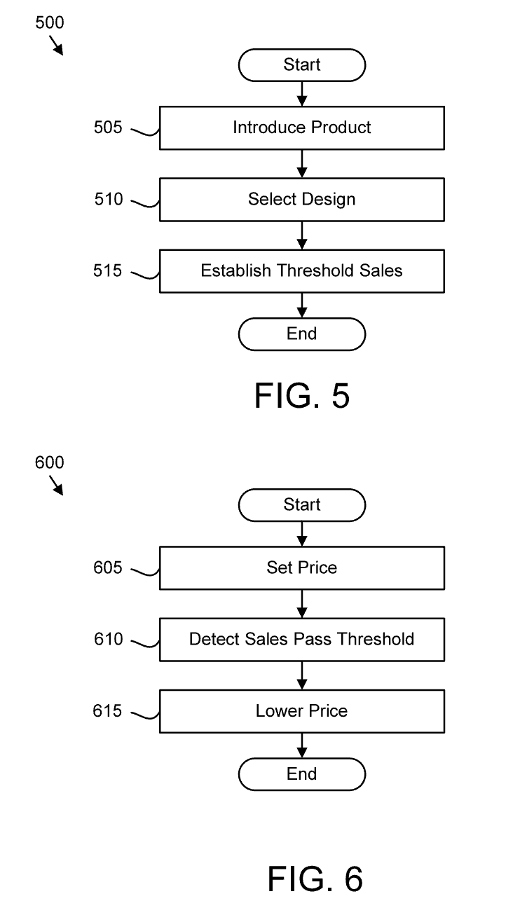

FIG. 7 depicts a third embodiment of a method 700 for a collaborative sales campaign. The method 700 begins and the sales module 315 manages 705 a product sales campaign on a website. The product sales campaign includes a product for sale on the website and the product sales campaign includes a plurality of supporters 220. The reward event module 325 detects 710 a reward event. Then, the reward module 330 credits 715 a reward to the particular supporter 220 in response to detecting the reward event. Then, the method 700 ends.

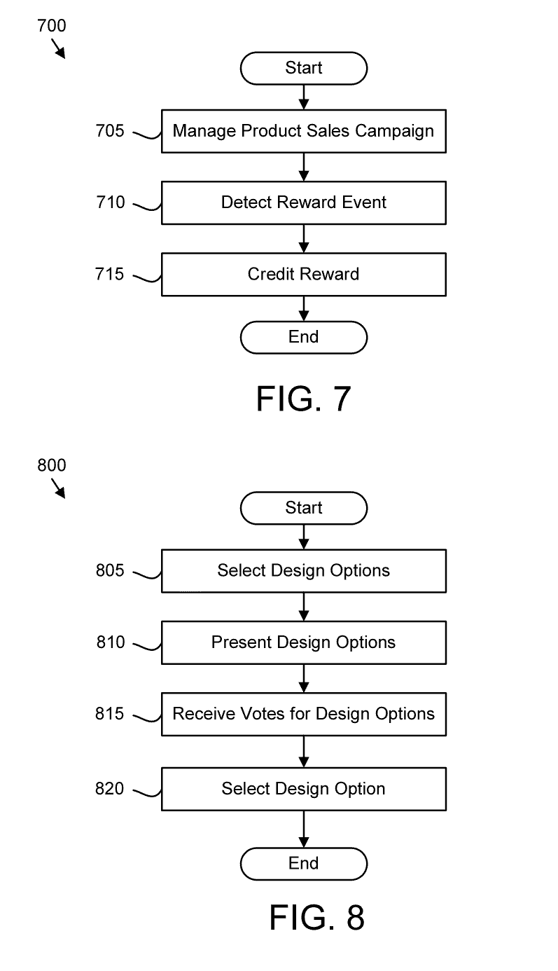

FIG. 8 depicts a fourth embodiment of a method 800 for a collaborative sales campaign. The method 800 begins and a design module 320 selects 805 a plurality of design options for a product. The design module 320 presents 810 the plurality of design options to a plurality of users on a website. The plurality of design options are for a product in a product sales campaign. The design module 320 receives 815 votes for design options of the plurality of design options from the plurality of users through the website. The users may include potential buyers of the product, supporters, and the like. The design module 320 selects 820 a particular design option of the plurality of design options. The particular design option has a highest number of votes. Then, the method 800 ends.

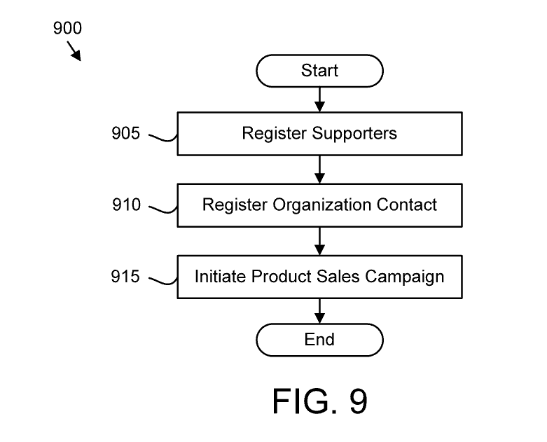

FIG. 9 depicts a fifth embodiment of a method 900 for a collaborative sales campaign. The method 900 begins and the supporter module 310 registers 905 a plurality of supporters 220 at a website for a product sales campaign associated with an organization 210. The number of the plurality of supporters 220 meets a predetermined threshold. The organization contact module 305 registers 910 an organization contact 225 at the website. The organization contact 225 represents the organization 210. Next, the sales module 315 initiates 915 the product sales campaign in response to registering the organization contact 225 and in response to registering the plurality of supporters 220. In certain embodiments, the product sales campaign is not commenced until the predetermined number of supporters 220 has been reached and until the organization contact 225 has registered. Then, the method 900 ends.

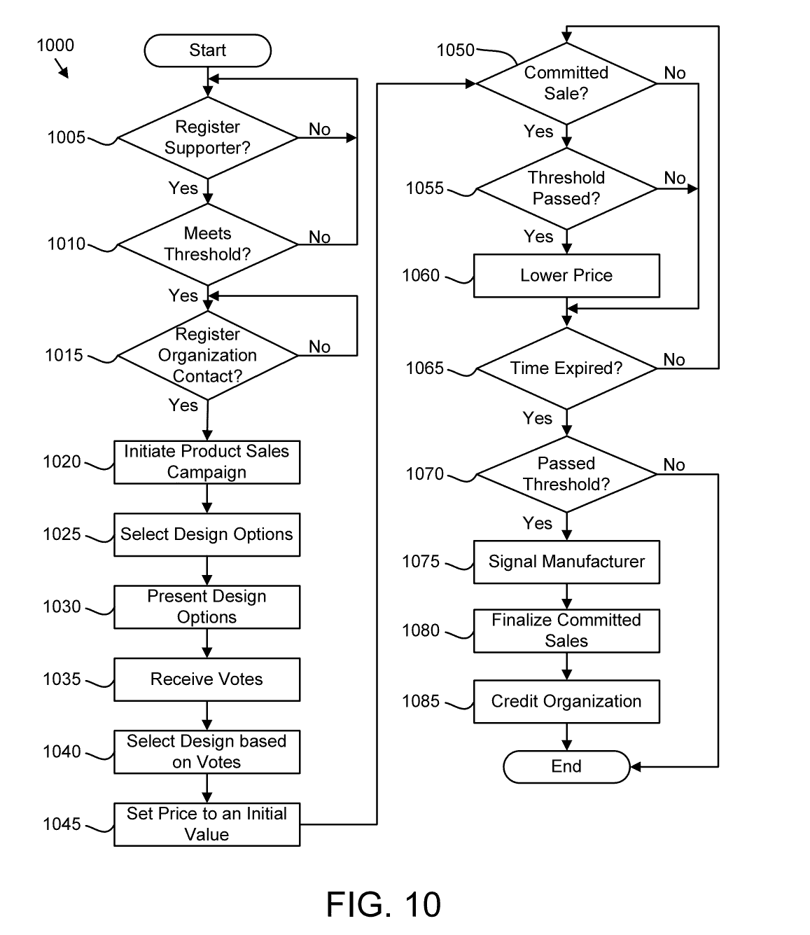

FIG. 10 depicts a sixth embodiment of a method 1000 for a collaborative sales campaign. The method 1000 begins and if the supporter module 310 registers 1005 a supporter 220, the sales module 315 determines 1010 whether the number of supporters 220 meets a predetermined threshold. If the number of supporters 220 meets the predetermined threshold and the organization contact module 305 registers 1015 an organization contact 225, the sales module 315 initiates 1020 a product sales campaign. Next, the design module 320 selects 1025 a plurality of design options for a product for the product sales campaign. The design module 320 presents 1030 the plurality of design options to a plurality of users on a website. The design module 320 receives 1035 votes for design options of the plurality of design options from the plurality of users through the website and the design module 320 selects 1040 a particular design option of the plurality of design options for the product sales campaign having a highest number of votes.

The sales module 315 sets 1045 a price of a product to an initial value. If the sales module 315 detects 1050 a committed purchase on the website of the product, the sales module 315 determines 1055 whether the number of committed purchases/number of products sold has passed a predetermined threshold (e.g. the tipping point). If the sales module 315 determines 1055 that the number of products sold has not passed the predetermined threshold, the method 1000 skips to step 1065. Alternatively, if the sales module 315 determines 1055 that the number of products sold has passed the predetermined threshold, the sales module 315 lowers 1060 the price of the product (e.g. the price that all buyers 230 will be charged at the end of the product sales campaign). Next, the sales module 315 determines 1065 whether the time of the product sales campaign has expired, if the time has not expired the method 1000 returns to step 1050 and the sales module 315 continues monitoring for committed purchases.

If the time for the product sales campaign has expired, the sales module 315 determines 1070 whether the number of products sold passed the threshold. If not, the method 1000 ends. If the number of products sold has passed the threshold, the product module 345 signals 1075 the manufacturer to manufacture the product. The product module 345 may also send instructions to the manufacturer including a quantity of products, the selected design option, and the like. The sale module finalizes 1080 the committed purchases and the credit module 340 credits 1085 the organization 210 with at least a portion of each finalized committed purchase. Note that during the product sales campaign, the supporter module 310 may continue to register new supporters 220. Then, the method 1000 ends.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an organization contact module configured to register an organization contact on a website, the organization contact representing the organization;
a supporter module configured to register a plurality of supporters at the website for a product sales campaign associated with an organization, a number of the plurality of supporters meeting a predetermined threshold;
a sales module configured to initiate the product sales campaign in response to registering the organization contact and in response to registering the plurality of supporters; and
a product module configured to signal a manufacturer of the product to produce the product in response to a number of committed purchases by the plurality of supporters exceeding the predetermined threshold.

2. The apparatus of claim 1, further comprising a design module configured to:
select a plurality of design options for a product for the product sales campaign;
present the plurality of design options to a plurality of users on a website, the plurality of users comprising at least a portion of the plurality of supporters;
receive votes for design options of the plurality of design options from the plurality of users through the website; and
select a particular design option of the plurality of design options for the product sales campaign, the particular design option having a highest number of votes.

3. The apparatus of claim 1, further comprising a reward event module configured to detect a reward event of a supporter of a product sales campaign.

4. The apparatus of claim 1, further comprising a reward module configured to detect a reward event associated with a supporter and credit a reward to the supporter in response to the reward event module detecting the reward event.

5. The apparatus of claim 1, further comprising an interface module configured to interface with one or more social media networks to facilitate the plurality of supporters referring a plurality of additional supporters.

6. The apparatus of claim 1, further comprising a credit module configured to credit the organization with at least a portion of each finalized committed purchase and credit the sales campaign provider with a portion of each finalized committed purchase.

7. The apparatus of claim 1, further comprising a buyer module configured to register a buyer in response to the buyer purchasing a product and record the buyer's payment information.

8. A method comprising:
registering a plurality of supporters at a website for a product sales campaign associated with an organization, a number of the plurality of supporters meeting a predetermined threshold;
registering an organization contact at the website, the organization contact representing the organization;
initiating the product sales campaign in response to registering the organization contact and in response to registering the plurality of supporters; and
signaling a manufacturer of the product to produce the product in response to a number of committed purchases by the plurality of supporters exceeding the predetermined threshold.

9. The method of claim 8, further comprising:
introducing a product to a sponsoring entity;
collaboratively selecting a design of the product; and
collaborating, through a website, to establish a threshold amount of committed purchases of the product.

10. The method of claim 8, further comprising:
setting a price of a product to an initial value, the product for sale on a website;
detecting a plurality of committed purchases of the product exceeds a predetermined threshold; and
lowering the price in response to each committed purchase above the predetermined threshold.

11. The method of claim 8, further comprising:
selecting a plurality of design options for a product for the product sales campaign;
presenting the plurality of design options to a plurality of users on a website, the plurality of users comprising at least a portion of the plurality of supporters;
receiving votes for design options of the plurality of design options from the plurality of users through the website; and
selecting a particular design option of the plurality of design options for the product sales campaign, the particular design option having a highest number of votes.

12. The method of claim 8, further comprising:
managing a product sales campaign on a website, the product sales campaign comprising a product for sale on the website, the product sales campaign comprising a plurality of supporters;
detecting a reward event of a particular supporter of the product sales campaign; and
crediting a reward to the particular supporter in response to detecting the reward event.

13. The method of claim 8, further comprising interfacing with one or more social media networks to facilitate the plurality of supporters referring a plurality of additional supporters.

14. A computer program product comprising a computer readable storage medium having computer readable program code embodied therein, the computer readable program code executed by a processor to perform the operations of:
registering a plurality of supporters at a website for a product sales campaign associated with an organization, a number of the plurality of supporters meeting a predetermined threshold;
registering an organization contact at the website, the organization contact representing the organization;
initiating the product sales campaign in response to registering the organization contact and in response to registering the plurality of supporters; and
signaling a manufacturer of the product to produce the product in response to a number of committed purchases by the plurality of supporters exceeding the predetermined threshold.

15. The computer program product of claim 14, further comprising:
introducing a product to a sponsoring entity;
collaboratively selecting a design of the product; and
collaborating, through a website, to establish a threshold amount of committed purchases of the product.

16. The computer program product of claim 14, further comprising:
setting a price of a product to an initial value, the product for sale on a website;
detecting a plurality of committed purchases of the product exceeds a predetermined threshold; and
lowering the price in response to each committed purchase above the predetermined threshold.

17. The computer program product of claim 14, further comprising:
selecting a plurality of design options for a product for the product sales campaign;
presenting the plurality of design options to a plurality of users on a website, the plurality of users comprising at least a portion of the plurality of supporters;
receiving votes for design options of the plurality of design options from the plurality of users through the website; and
selecting a particular design option of the plurality of design options for the product sales campaign, the particular design option having a highest number of votes.

18. The computer program product of claim 14, further comprising:
managing a product sales campaign on a website, the product sales campaign comprising a product for sale on the website, the product sales campaign comprising a plurality of supporters;
detecting a reward event of a particular supporter of the product sales campaign; and
crediting a reward to the particular supporter in response to detecting the reward event.

19. The computer program product of claim 14, further comprising crediting the organization with at least a portion of each finalized committed purchase.

20. The computer program product of claim 14, further comprising interfacing with one or more social media networks to facilitate the plurality of supporters referring a plurality of additional supporters.
